(19) United States
(12) Patent Application Publication
(10) Pub. No.: US 2008/0279750 A1
(43) Pub. Date: Nov. 13, 2008

(54) Method of Manufacturing Nano-Loops Using Branched Nanostructures

(75) Inventor: Hope Chik, Windham, NH (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/694,594

(22) Filed: May 7, 2007

(51) Int. Cl. C01B 31/02

(52) U.S. Cl. 423/445 B; 977/842

(57) ABSTRACT

A method of manufacturing nano-loops is disclosed in which branched nanostructures are formed in a template. A branched nanostructure comprises a stem and at least two branches, each branch emanating from the stem at a branch point. A first part of the template is removed to expose the nanostructure stems and stem ends of the nanostructure branches. The exposed stem ends of the nanostructure branches form the nano-loops. Optionally, the free ends of the branches may be exposed and embedded in a layer of supporting material.

### FIELD OF THE INVENTION

The present invention relates generally to nanostructure manufacture and, in particular, to the manufacture of nano-loops.

### BACKGROUND

Current electronic assembly involves the use of elevated mass reflow temperatures, typically above 240° C., to form solder joints between the components and printed wiring board. This high temperature process introduces thermal excursions and strains increasing the reliability risk and complexity of the qualification processes. Temperature sensitive components already bypass the mass reflow stage and are assembled in a separate selective soldering stage. This adds to the product costs and reduces assembly throughput.

Hoop and loop adhesion schemes, such as VELCRO™ are widely used. VELCRO™ is a trademark of Velcro Industries, B.V.

The idea of using nanostructure ‘hook & loop’ adhesion schemes has been proposed as a room temperature technology to replace the need for high temperature soldering. However, to date there are no known techniques to make anchored nano-sized loops.

Patent publication number WO 99/40812, titled “Micro-Fastening System and Method of Manufacture” describes the use of a nano-scale hook and loop fastening system to provide mechanical adhesion between two bonding surfaces. The nano-scale hook and loop fastening system is realized with hook-shaped terminating nanostructures, termed ‘nanohooks’, interlocking with one another. The nanohook functions as both the hook and the loop.

The practical realization of nanohook structures, however, has not been reduced to common practice. No controlled growth recipes to fabricate the nanohooks, in any material system, have been disclosed. The manipulation of normally straight carbon nanotubes, as an example, into nanohooks requires the substitution of the stable hexagon carbon configuration with energetically unfavorable pentagon-heptagon pairs to produce the permanent bend.

Several techniques have been disclosed for the fabrication of carbon nanotube ring structures. However, the carbon nanotube rings are isolated structures and are not anchored to any surface. Therefore, ‘as-grown’ carbon nanotube rings cannot be used as a loop in a ‘hook & loop’ attachment scheme.

Carbon nanotubes (CNT's) have generated great interest for application in a broad range of potential nanodevices due to their unique structural and electronic properties. Although first reported in 1952, extensive efforts to control the growth and properties of CNT's were not made until the 1990s. Large quantities of carbon nanotubes can be produced by arc discharge, laser ablation, or chemical vapor deposition methods. However, the application of CNT's, prepared using the aforementioned methods, has been hampered because of the limited uniformity of the nanotubes and difficulties with the alignment.

In contrast, template-confined growth of CNT's permits the production of large areas of highly ordered, isolated long CNT's with monodispersed tube diameter and length. In particular, the diameter, length, and packing density of CNT's can be well controlled when the nanotube arrays are fabricated in porous anodic aluminum oxide (AAO) templates. Typically, either carbonization of polymers or pyrolysis of gaseous hydrocarbons has been used to produce CNT's in AAO templates. However, these procedures are not without drawbacks.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIGS. 1-5 illustrate a method of manufacturing nano-loop in accordance with some embodiments of the invention.

FIG. 6 is a diagrammatic representation of the use of a nano-scale hook and loop system for electronic assembly in accordance with some embodiments of the invention.

FIG. 7 is a flow chart of a method of manufacturing nano-loop in accordance with some embodiments of the invention.

FIG. 8 is a block diagram of a conventional electronic assembly system.

FIG. 9 is a block diagram of an electronic assembly system in accordance with some embodiments of the invention.

FIGS. 10-13 illustrate a further method of manufacturing nano-loop in accordance with some embodiments of the invention.

FIGS. 14-16 illustrate a still further method of manufacturing nano-loop in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to the manufacture of nano-loops. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The present invention relates to a method of nano-loop manufacturer in which branched nanostructures are transformed into nanosized loops. A branched nanostructure is a structure with a single stem that splits into at least two branches, each branch emanating from the stem at a branch point. The structure may be a single crystalline structure or a multi-crystal structure.

Such structures have been grown using carbon nanotubes as well as metal nanowires. The nano-loops so formed may be used in ‘hook and loop’ adhesion schemes. ‘Hook and loop’ adhesion schemes may be used to replace solder in electronic assembly and in a variety of other applications, including mechanical assembly.

A nanostructure is a structure having at least one dimension that is of the order of nanometers. For example, nanotubes typically have diameters ranging from a few nanometers to a few hundred nanometers.

In accordance with one embodiment of the invention branched nanostructures are first formed in a template. A branched nanostructure comprises a stem and at least two branches, each branch emanating from the stem at a branch point and having a stem end and a free end. A first part of the template is removed to expose the ends of the nanostructure branches that emanate from stem at the branch points. The exposed stem ends of the nanostructure branches form the nano-loops.

Optionally, prior to removing a first part of the template, the free ends of the nanostructure branches may be exposed and embedded in a layer of supporting material. The free ends of the nanostructure branches ends may be exposed by removing a second part of the template to expose the free ends of the nanostructure branches, or by forming the nanostructure such that the free ends of the nanostructure branches extend beyond the surface of the template.

An attachment system comprises a first structure having a plurality of nano-scale hooks and a second structure comprising a plurality of nano-scale loops.

Templates, such as self-organized anodized aluminum oxide membranes, have been used successfully to create straight and Y-shaped carbon nanotubes. An anodized aluminum oxide membrane is self-ordered to form a hexagonally packed array. An advantage of using a template grown is that the dimensions of the Y-shaped nanostructure can be controlled. The length of the Y-branch, and the length and diameter of the un-branched nanostructure (the stem) can be grown to desired specifications.

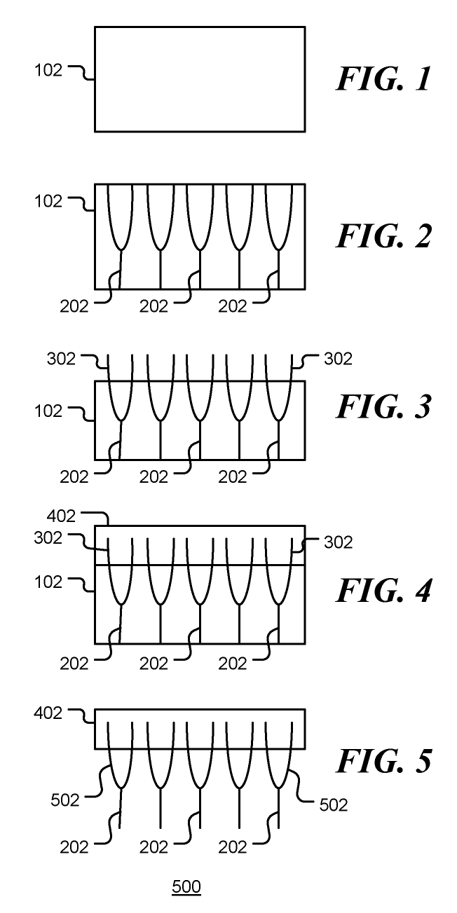

An embodiment of a method in accordance with the present invention is shown in FIG.1 to FIG. 5. The process begins with a template 102 shown in FIG. 1. The template may be a self-organized anodized aluminum oxide (AAO) membrane, for example. While other templates may be used, the use of the AAO membrane offers some advantages over other templates for the fabrication of nanostructures. In particular, AAO membranes are readily fabricated according to methods known in the art. Moreover, the pore size and spacing of the pores can be controlled during the synthesis of the AAO membrane. The shape of the nano-structure will conform to the membrane configuration. Thus, branched nano-structures, with branches emanating from one or more branch points may be formed.

The template is used to grow branched nanostructures 202 as illustrated in FIG. 2. The template confines growth of the nanostructures and permits the production of large areas of highly ordered, isolated nanostructures with consistent tube diameter and length. In particular, the diameter, length, packing density and number of branches of nanostructures can be well controlled when they are fabricated in anodized aluminum oxide (AAO) templates. In addition, the relative lengths of the stem and branch sections of the branched nanostructure may be controlled. Techniques for growing Y-shaped nanostructures are known in the art. The pore size of the AAO membrane is chosen to facilitate the fabrication of the nanostructures. The branched nanostructures each comprise a stem coupled to two or more branches. Each branch has a stem end, which emanates from the stem, and a free end.

To transform the template grown branched nanostructure into a nano-loop, the free ends 302 of the branched nanostructure are first exposed to a certain length by removing some of the template material as shown in FIG. 3. This may be done by wet or dry etching or by ion milling, for example. The AAO membrane may be removed from the ends of the nanostructures by exposure of the membrane to a solution of alkali such as sodium hydroxide, potassium hydroxide, and the like, or by other means.

Next, as shown in FIG. 4, a layer of supporting material 402 is deposited onto the newly etched surface encapsulating the exposed free ends 302 of the branches. For application to electronic assembly, the supporting material may be an electrically conductive material, such as solder, for example. In addition, the support material may be thermally conductive. Non-conductive materials may be used for other applications. The high heat resistance of the AAO membrane allows relatively high temperatures to be used for depositing the conductive layer. The top layer may be, for example, a single metal, an alloy or a conductive polymer. Suitable metals for use in the methods include bismuth, lead, aluminum, tin, zinc, indium, antimony and other low melting point metals (e.g., metals melting at or below about 550.degree. C.), alloys or combinations thereof. The top layer of metal can range from about 100 nm to about 1, 2, 3, 4, or even 5 μm thick. The top layer of metal can be deposited by any suitable method known to those of skill in the art, including sputtering, evaporation and electro-deposition.

Finally, as shown in FIG. 5, the nano-loop structure 500 is obtained by removing the remaining anodized aluminum oxide material to expose the nano-loops 502. The nano-loops 502 are embedded in the conductive layer 402. The exposed stem ends of the branches form the nano-loops. The conductive layer may be, for example, a layer of solder on the surface of an electronic component.

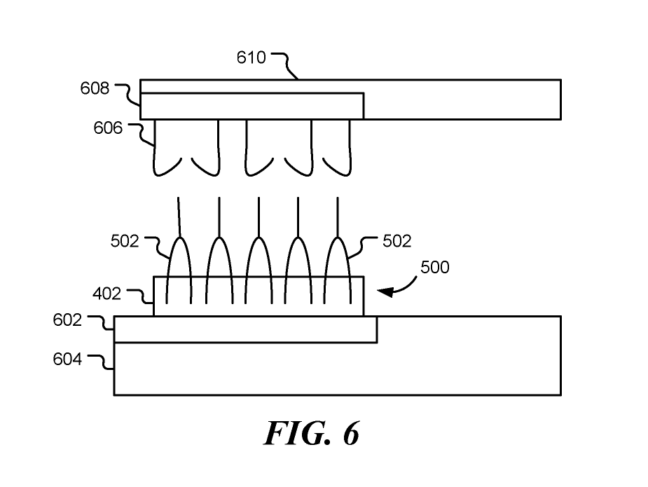

FIG. 6 is a diagrammatic representation of an exemplary use of a hook and loop adhesion scheme in electronic assembly. The use of hook and loop adhesion schemes for electronic assembly could eliminate the need for high temperature soldering since only a preload force, applied at room temperature, is necessary for bonding. The proposed branched loop structure can be viewed as an enabling technology for the ‘hook and loop’ attachment scheme. Referring to FIG. 6, the nano-loop structure 500 is integrated onto the bonding surfaces 602 of a circuit board 604. This may be achieved by a pre-component placement transfer process. The transfer of carbon nanotubes onto a surface using solder has been demonstrated with good transfer characteristics.

A corresponding nano-scale hoop structure 606 is attached to the bonding surface 608 of a component 610. The component 610 may be mechanically and electronically connected to the circuit board 604 simply be pressing the two parts together. Thus, the ‘hook and loop’ attachment scheme can be used to replace soldering processes in electronic assembly.

The relative sizes of the hooks and loop are selected such that a plurality of hooks and loops interlock when the first and second structure are brought together. This may be achieved, for example, by making the loops similar in size to the hooks.

It will be apparent to those of ordinary skill in the art that a nano-scale hook and loop system may be used in a variety of other applications. For example, the system may be used for purely mechanical attachment—such as the assembly of cell phone housings or battery housings. The system may be used as general mechanical adhesive, similar to conventional, large scale hook and loop systems, such as VELCRO™.

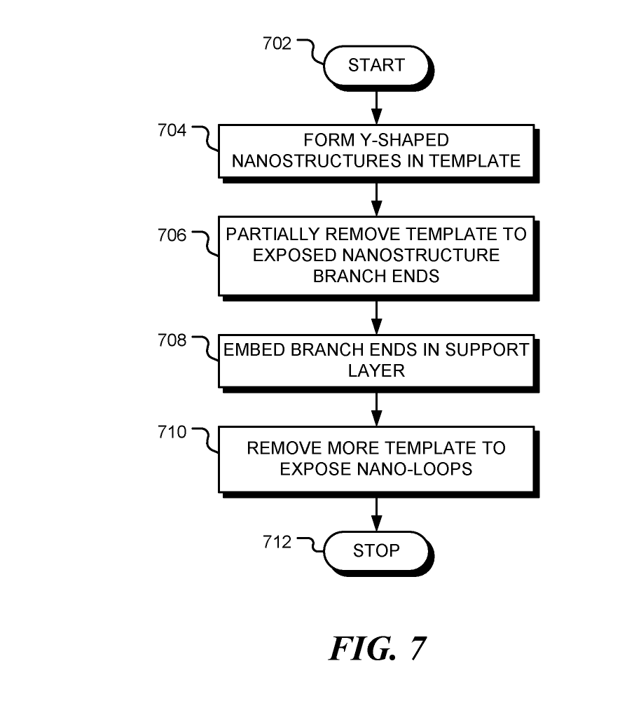

FIG. 7 is a flow chart of a method for manufacturing nano-loops in accordance with certain embodiments of the invention. Following start block 702 in FIG. 7, a branched nanostructure is formed in a template, such as an AAO membrane, at block 704. At block 706, the free ends of the nanostructure branches are exposed by removing some of the template material. This may be done by etching, for example. At block 708, the exposed nanostructure branch free ends are embedded in a support layer. The support layer may be deposited onto the surface of the template using known techniques. Finally, at block 710, more template material is removed to expose a part of the nanostructure that includes the junction between the stem of the branched nanostructure and the branches of the branched nanostructure. The exposed branches form the nanostructure loop.

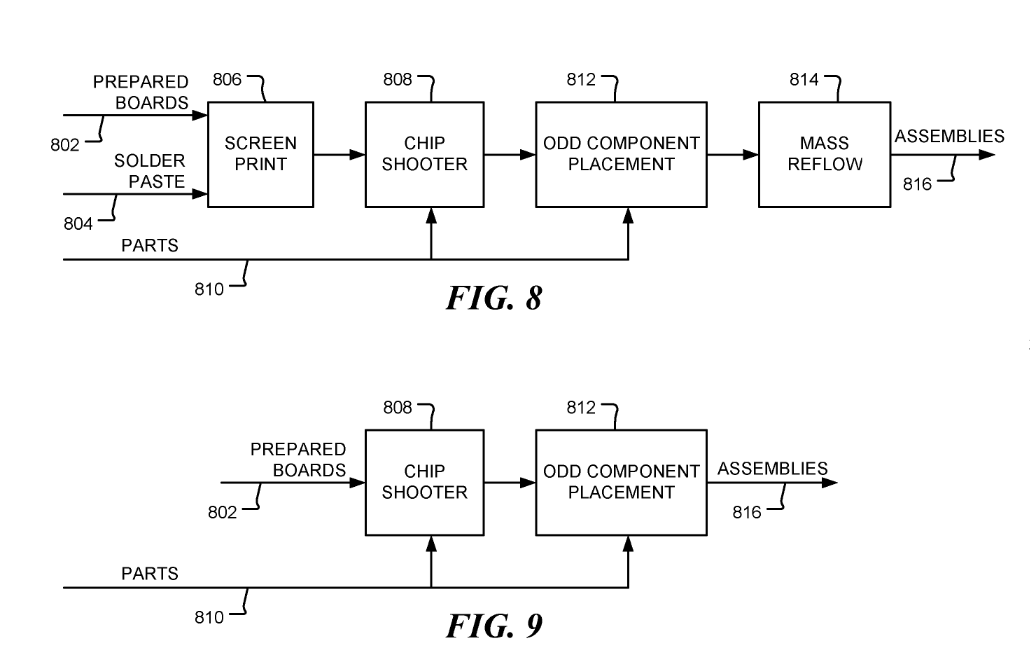

FIG. 8 is a block diagram of a conventional electronic assembly system. In this system, prepared boards 802 and solder paste 804 is supplied to a screen print station 806 that applies the solder paste to the appropriate areas of the boards. The boards are then passed to a chip shooter 808 that positions parts 810 at the appropriate locations. The boards then pass to odd component station 812, where additional parts 810 are positioned on the boards. Finally, at mass reflow station 814, the solder paste is flowed to form the mechanical and electrical connections between the parts and the boards. This produces the final assemblies (boards with attached components) 816.

FIG. 9 is a block diagram of an electronic assembly system in accordance with some embodiments of the invention. In the system of the invention, solder is not used to attach the component parts to the boards. Thus, the screen print station 806 and the mass reflow station 814 shown in FIG. 8 are not needed. Referring to FIG. 9, the prepared boards 802 are passed to the chip shooter 808 that positions parts 810 at the appropriate locations. The boards then pass to odd component station 812, where additional parts 810 are positioned on the boards. When a nano-scale hook and loop scheme is used, the act of positioning of the parts on the boards is sufficient to adhere the parts to the board and to form the required electrical connections. Since solder is not used, the resulting assemblies 816 are more stable to moisture, humidity, UV light, chemicals and high temperature exposure. In addition, since lower assembly temperatures are used, the designer is freed to use different materials. Still further, since the attachment is very compact, it frees up space on the boards.

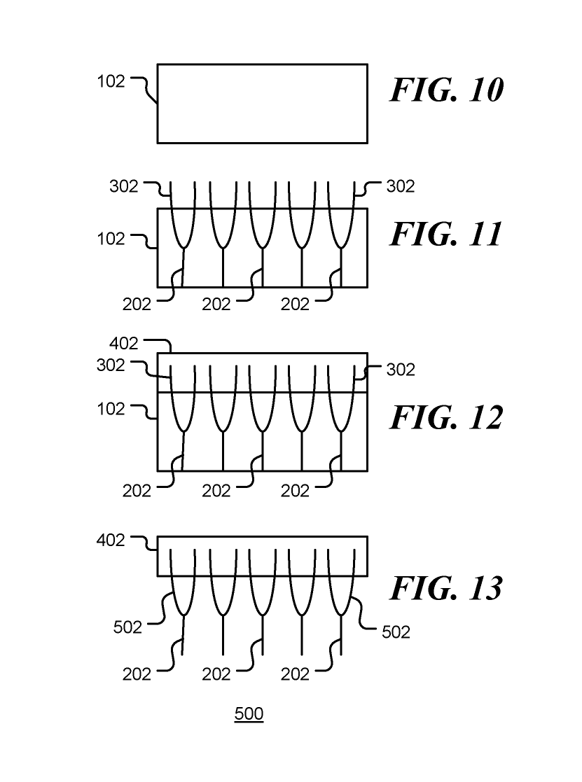

FIGS. 10-13 illustrate a further method of manufacturing nano-loop in accordance with some embodiments of the invention. The method begins with a template 102 shown in FIG. 10. The template is used to grow branched nanostructures 202 as illustrated in FIG. 11. The template confines growth of the nanostructures and permits the production of large areas of highly ordered, isolated nanostructures with consistent tube diameter and length. The nanostructures 202 are grown beyond the AAO membrane surface so that the ends 302 of the nanostructures are exposed. Next, as shown in FIG. 12, a layer of supporting material 402 is deposited onto the newly etched surface encapsulating the exposed free ends 302 of the branches. For application to electronic assembly, the supporting material may be an electrically conductive material, such as solder, for example. In addition, the support material may be thermally conductive. Non-conductive materials may be used for other applications. The high heat resistance of the AAO membrane allows relatively high temperatures to be used for depositing the conductive layer. The top layer may be, for example, a single metal, an alloy or a conductive polymer. Suitable metals for use in the methods include bismuth, lead, aluminum, tin, zinc, indium, antimony and other low melting point metals, alloys or combinations thereof Finally, as shown in FIG. 13, the nano-loop structure 500 is obtained by removing the remaining anodized aluminum oxide material to expose the nano-loops 502. The nano-loops 502 are embedded in the conductive layer 402. The exposed stem ends of the branches form the nano-loops.

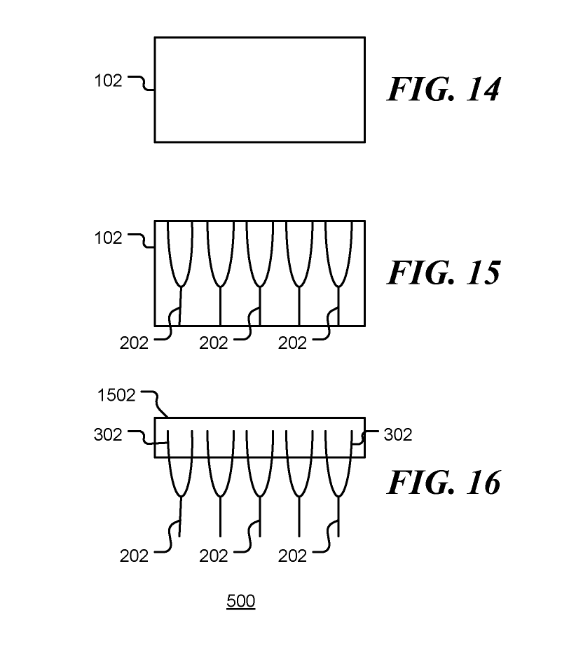

FIGS. 14-16 illustrate a still further method of manufacturing nano-loop in accordance with some embodiments of the invention. The method begins with a template 102 shown in FIG. 14. The template is used to grow branched nanostructures 202 as illustrated in FIG. 15. Finally, as shown in FIG. 16, the nano-loop structure 500 is obtained by removing a lower portion of the anodized aluminum oxide material to expose the nano-loops 502. The nano-loops 502 are embedded in the remaining template layer 1502. The exposed stem ends of the branches form the nano-loops.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method of manufacturing nano-loops comprising:
forming branched nanostructures in a template, a branched nanostructure comprising:
a stem; and
at least two branches, each branch emanating from the stem at a branch point and having a stem end and a free end; and
removing a first part of the template to expose the stem ends of the nanostructure branches;
wherein the exposed nanostructure branch stem ends form the nano-loops.

2. A method in accordance with claim 1, further comprising, prior to removing a first part of the template:
exposing the free ends of the nanostructure branches; and
embedding the free ends of the nanostructure branches in a layer of supporting material.

3. A method in accordance with claim 2, wherein exposing the free ends of the nanostructure branches ends comprises removing a second part of the template to expose the free ends of the nanostructure branches.

4. A method in accordance with claim 3, wherein removing the second part of the template to expose the free ends of the nanostructure branches comprises etching the template.

5. A method in accordance with claim 2, wherein exposing the free ends of the nanostructure branches ends comprises forming the nanostructure such that the free ends of the nanostructure branches extend beyond the surface of the template.

6. A method in accordance with claim 2, wherein the layer of supporting material is electrically and thermally conductive.

7. A method in accordance with claim 2, wherein the layer of supporting material comprises at least one metal.

8. A method in accordance with claim 2, wherein the layer of supporting material comprises at least one conductive polymer.

9. A method in accordance with claim 2, wherein embedding the exposed free ends of the nano structure branches in the layer of supporting material comprises forming a layer of supporting material on the template.

10. A method in accordance with claim 1, wherein the template comprises an anodized aluminum oxide membrane.

11. A method in accordance with claim 1, wherein the branched nanostructures comprise branched carbon nano-tubes.

12. A plurality of nano-loops formed by the method of claim 1.

13. A nano-scale hook and loop system comprising a nano-loop structure and a nano-hook structure, wherein the nano-loop structure comprises a plurality of nano-loops formed by the method of claim 1.

14. An attachment system comprising:
a first structure comprising a plurality of nano-scale hooks;
a second structure comprising a plurality of nano-scale loops;
wherein the nano-scale loops are formed by:
forming branched nanostructures in a template, a branched nanostructure comprising:
a stem; and
at least two branches, each branch emanating from the stem at a branch point and having a stem end and a free end; and
removing a first part of the template to expose the stem ends of the nanostructure branches, the exposed stem ends of the nanostructure branches forming the nano-scale loops.

15. An attachment system in accordance with claim 14, further comprising, prior to removing a first part of the template:
exposing the free ends of the nanostructure branches ends; and
embedding the exposed free ends of the nanostructure branches in a layer of supporting material.

16. An attachment system in accordance with claim 15, wherein exposing the free ends of the nanostructure branches comprises removing a second part of the template to expose the free ends of the nanostructure branches.

17. An attachment system in accordance, with claim 16, wherein removing the second part of the template to expose the free ends of the nanostructure branches comprises etching the template.

18. An attachment system in accordance with claim 15, wherein the layer of supporting material is electrically and thermally conductive.

19. An attachment system in accordance with claim 18, wherein the first structure is attached to a first element of an assembly and the second structure is attached to a second element of an assembly and wherein the first and second elements of the assembly are mechanically coupled by interlocking of the nano-scale hooks with the nano-scale loops.

20. An attachment system in accordance with claim 15, wherein the layer of supporting material comprises at least one metal.

21. An attachment system in accordance with claim 15, wherein the layer of supporting material comprises at least one conductive polymer.

22. An attachment system in accordance with claim 14, wherein the template comprises an anodized aluminum oxide membrane.

23. A method in accordance with claim 14, wherein the assembly is an electronic assembly and wherein the first and second elements of the assembly are mechanically and electrically coupled by interlocking of the nano-scale hooks with the nano-scale loops.

24. A method in accordance with claim 14, wherein the assembly is an electronic assembly and wherein the first and second elements of the assembly are thermally coupled by interlocking of the nano-scale hooks with the nano-scale loops.

25. An attachment system in accordance with claim 14, wherein the relative sizes of the hooks and loop are selected such that a plurality of hooks and loops interlock when the first and second structure are brought together.

26. A system for manufacturing nano-loops, the system comprising:
a means for forming branched nano-structures in a template, a nano-structure comprising a stem and at least two branches emanating from the stem at a branch point, each branch having a stem end and a free end; and
a means for removing a first part of the template to expose the stems and the stem ends of the nanostructure branches,
wherein the stem ends of the nanostructure branches form the nano-loops.

27. A system in accordance with claim 26, further comprising:
a means for exposing the free ends of the nano-structure branches; and
a means for embedding the exposed free ends of the nanostructure branches in a support material.

28. A system in accordance with claim 27, wherein the support material is electrically conductive.

29. A system in accordance with claim 28, wherein the support material is electrically conductive.

30. A system in accordance with claim 27, wherein the template comprises anodized aluminum oxide membrane.

31. A system in accordance with claim 27, wherein the branched nanostructures are made of carbon.
